(19) United States
(12) Patent Application Publication
(10) Pub. No.: US 2010/0066301 A1
(43) Pub. Date: Mar. 18, 2010

(54) FLUSH APPARATUS

(76) Inventors: Chieh-Cheng CHEN, Taoyuan Hsien (TW); Chi-Ching LEE, Taoyuan Hsien (TW); Ching-Liang CHIU, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/258,962

(22) Filed: Oct. 27, 2008

(30) Foreign Application Priority Data
Sep. 18, 2008 (TW) 097135726

(51) Int. Cl. H01M 10/46

(52) U.S. Cl. 320/101

(57) ABSTRACT

A flush apparatus includes a control module, a solar cell and a rechargeable battery. The control module is used for controlling the flush apparatus to flush or not. The solar cell and the rechargeable battery are electrically connected to a power output terminal in parallel. The power output terminal is electrically connected to the control module for providing power to the control module.

### CROSS REFERENCE TO RELATED APPLICATIONS

This Non-provisional application claims priority under 35 U.S.C. §119(a) on Patent Application No(s). 097135726 filed in Taiwan, Republic of China on Sep. 18, 2008, the entire contents of which are hereby incorporated by reference.

### BACKGROUND OF THE INVENTION

1. Field of Invention

The present invention relates to a flush apparatus and, in particular, to a solar flush apparatus that uses the solar cell or rechargeable battery as the power source of the latching solenoid valve.

2. Related Art

The traditional automatic flush apparatus is applied to the automatic flush urinal or automatic scrubber, and it is designed to match the city electricity standards. Nevertheless, the electronic control elements are still driven by the direct current, so the city electricity, which is alternating current, must be transformed to the direct current for the electronic control circuits. It is commonly to use a converter to perform the voltage converting. Generally, the converter will consume a lot of energy, such as the heat or magnetic energy loss. If the solenoid valve used in the alternating-current product is not a latching solenoid valve, the power consumption for keeping the solenoid valve open will be impressive.

Since the above-mentioned alternating-current flush apparatus needs a conventional converter, the cost and the volume thereof are increased. In addition, the assembling thereof is more difficult and complex than other product of the same model. Moreover, the building must have the preset power lines for installing the product later, so that this kind of product cannot be popularized.

Regarding to a direct-current automatic flush apparatus, the supplied power is the direct current, which is supplied by batteries. Although it is easy to install this product, the lifetime thereof is sufficiently restricted by the voltage of the battery. That is, the batteries must be replaced in a short time so as to remain the function of the flush apparatus. This will also produce a great amount of drained batteries, which causes the pollution and load of the environment.

If the battery is a rechargeable battery, a battery charger with the converter is needed. Thus, the installation of the automatic flush apparatus is more difficult and complex than other products of the same model, and the preset power lines in the building are still needed for installing the automatic flush apparatus so the products cannot be popularized. Accordingly, the drawback of the automatic flush apparatus with the alternating-current power source can not be overcome.

In addition, the automatic flush apparatus with the direct-current power source usually cooperates with the latching solenoid valve, which has less power consumption, because the voltage of the used batteries is too small. The drawback of the latching solenoid valve is that there is no effective debugging method as the valve is failed (shut down or malfunctioned). If the solenoid valve can not accurately control to turn off the hydrant, the serious waste in water resource may occur and the difficulty for dealing with this problem is increased.

### SUMMARY OF THE INVENTION

In view of the foregoing, an object of the present invention is to provide a flush apparatus with a solar cell and a rechargeable battery electrically connected to the power output terminal in parallel as a power source, so as to sufficiently increase the using time of the rechargeable battery.

Another object of the present invention is to provide a flush apparatus including a boosting unit and an isolation-determining circuit for boosting the electricity outputted from the solar cell, so that the flush apparatus with the small-size solar cell or in the condition of insufficient environmental light can operate normally.

To achieve the above objects, the present invention discloses a flush apparatus including a control module, a solar cell and a rechargeable battery. The control module is used for controlling the flush apparatus to flush or not. The solar cell and the rechargeable battery are electrically connected to a power output terminal in parallel, and the power output terminal is electrically connected to the control module for providing power to the control module. In one embodiment, the flush apparatus further includes a boosting unit disposed between the solar cell and the power output terminal so as to boost the electricity outputted from the solar cell.

As mentioned above, the flush apparatus of the present invention can be applied with a small-size solar cell or in the condition of insufficient environmental light. The flush apparatus of a first embodiment can use the capacitor, boosting unit and isolation-determining circuit to boost the voltage of the solar cell. In addition, the solar cell is connected with the rechargeable battery in parallel, so that both the small-size solar cell and the rechargeable battery can be used as the power supply. When the large-size solar cell is used or the environmental light is sufficient, the solar cell and rechargeable battery, which are connected in parallel, can be used as the power supply without the boosting unit and the isolation-determining circuit. In this case, the solar cell can output electricity to the rechargeable battery continuously, thereby extending the using time of the rechargeable battery.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic illustration showing a flush apparatus according to a first embodiment of the present invention; and

FIG. 2 is a schematic illustration showing a flush apparatus according to a second embodiment of the present invention.

### DETAILED DESCRIPTION OF THE INVENTION

The present invention will be apparent from the following detailed description, which proceeds with reference to the accompanying drawings, wherein the same references relate to the same elements.

### First Embodiment

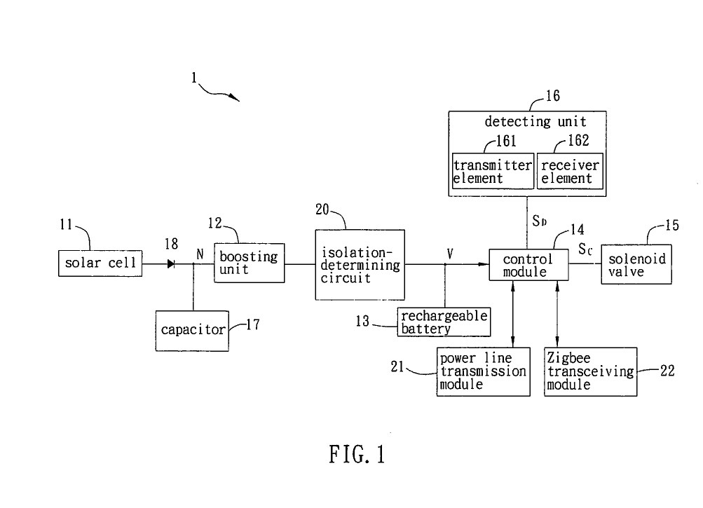

FIG. 1 is a schematic illustration showing a flush apparatus 1 according to a first embodiment of the present invention. Referring to FIG. 1, the flush apparatus 1 includes a solar cell 11, a boosting unit 12, a rechargeable battery 13, a control module 14, a solenoid valve 15 and a detecting unit 16.

In the embodiment, the solar cell 11 receives the environmental light and then converts solar energy into electricity. When the working voltage of the solar cell 11 is smaller than an electromotive force (EMF) of the rechargeable battery 13 (this usually occurs when the small-size solar cell is used or the environmental light is insufficient), the solar cell 11 is electrically connected to the boosting unit 12 such as a booster. Then, the solar cell 11 and the rechargeable battery 13 are connected to a power output terminal V in parallel. The power output terminal V is electrically connected to the control module 14 for providing power to the control module 14.

The solenoid valve 15 is the flushing switch of the flush apparatus 1. The control module 14 includes a microcontroller. The control module 14 is electrically connected to the solenoid valve 15 for controlling the ON/OFF of the solenoid valve 15.

In addition, the flush apparatus 1 further includes an isolation-determining circuit 20. A first terminal of the isolation-determining circuit 20 is electrically connected to the boosting unit 12, and a second terminal of the isolation-determining circuit 20 is electrically connected to the power output terminal V. The isolation-determining circuit 20 is used for preventing the control module 14 from retrieving current directly from the boosting unit 12 after the electricity of the solar cell is boosted by the boosting unit 12 so as to avoid the voltage drop of the power output terminal V such that the rechargeable battery 13 cannot be charged. However, in the condition of small power consumption load that does not greatly affect the output voltage of the boosting unit 12, the isolation-determining circuit 20 can be omitted

Moreover, the flush apparatus 1 of the embodiment further includes a capacitor 17 and a diode 18. The capacitor 17 is used to pre-store charges generated from the solar cell 11. The capacitor 17 and the solar cell 11 are electrically connected to a node N in parallel, and the node N is electrically connected to the boosting unit 12. The solar cell 11 is electrically connected to an anode of the diode 18, and a cathode of the diode 18 is electrically connected to the node N so as to prevent the current reverse back to the solar cell 11.

The flush apparatus 1 of the present invention is a solar flush apparatus, which uses the power sources from both the solar cell 11 and the rechargeable battery 13 as the power supply. These two kinds of power sources can be used cooperatively for providing the power to the control module 14. When the environmental light illuminates the solar cell 11, the solar cell 11 can be charged and the EMF of the solar cell 11 can be increased. After boosted by the boosting unit 12, the voltage of the power output terminal V can be increased. When the voltage of the power output terminal V is greater than the EMF of the rechargeable battery 13, the solar cell 11 becomes the main power source for providing the power to the control module 14 and charging the rechargeable battery 13. When the environmental light is weak, the EMF of the solar cell 11 is decreased, so that the voltage of the power output terminal V, after boosted by the boosting unit 12, is decreased. When the voltage of the power output terminal V is smaller than the EMF of the rechargeable battery 13, the rechargeable battery 13 automatically becomes the main power source. In this case, the output of the solar cell 11 is boosted by the boosting unit 12 and is then provided for charging the rechargeable battery 13 or directly applying power to the load. The rechargeable battery 13 can ensure to provide the stable and continuous power source to the load.

The detecting unit 16 is electrically connected to the control module 14 for detecting whether a user exists or not in front of the flush apparatus 1 and then transmitting a detecting signal S_{D} to the control module 14. The control module 14 outputs a driving power source Sc to the solenoid valve 15 according to the detecting signal S_{D} so as to control the ON/OFF of the solenoid valve 15. In the embodiment, the detecting unit 16 can be an infrared detecting unit and include a transmitter element 161 and a receiver element 162. Taking an automatic flush urinal as an example, when the user starts to use the flush apparatus 1, the transmitter element 161 transmits an infrared signal and the receiver element 162 receives the infrared signal reflected by the user so as to determine that the user exists. Thereafter, when the user leaves, the receiver element 162 can not receive the infrared signal reflected by the user, so that it is determined that the user has left. When the detecting unit 16 determines that the user has left, the control module 14 provides a driving power source Sc to the solenoid valve 15 so as to control a flushing time of the flush apparatus 1 according to a using time and/or a using frequency of a user.

In addition, the flush apparatus 1 further includes a power line transmission module 21 or a Zigbee transceiving module 22 for bidirectional data transmission with the control module 14. The control module 14 outputs the detecting information such as a value of the EMF of the rechargeable battery 13 and a visitor number of the flush apparatus 1 through the power line transmission module 21 or the Zigbee transceiving module 22. Then a master control terminal can modify a control loop program of the control module 14 through the power line transmission module 21 or the Zigbee transceiving module 22.

### Second Embodiment

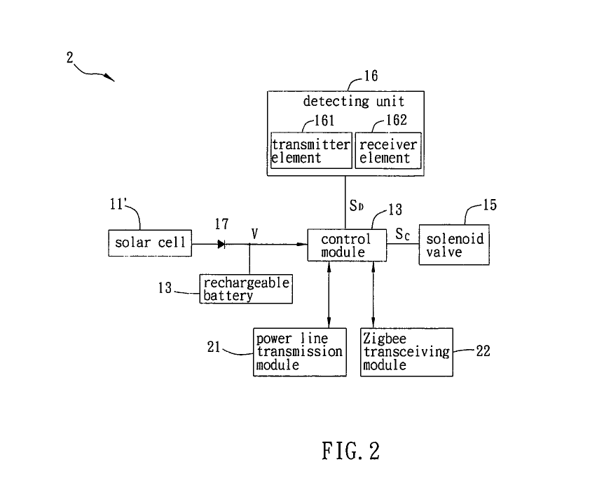

FIG. 2 is a schematic illustration showing a flush apparatus 2 according to a second embodiment of the present invention. Referring to FIG. 2, the flush apparatus 2 includes a solar cell 11′, a rechargeable battery 13, a control module 14, a solenoid valve 15 and a detecting unit 16. The difference between the flush apparatus 2 and the flush apparatus 1 of the first embodiment is in that the working voltage of the solar cell 11′ is greater than the EMF of the rechargeable battery 13. Thus, the flush apparatus 2 does not need the capacitor 17, boosting unit 12 and isolation-determining circuit 20 described in the first embodiment.

In the embodiment, the flush apparatus 2 uses the power sources from both the solar cell 11′ and the rechargeable battery 13 as the power supply. These two kinds of power sources can be used cooperatively for providing the power to the control module 14. When the environmental light illuminates the solar cell 11′, the solar cell 11′ can be charged and the EMF of the solar cell 11′ as well as the voltage of the power output terminal V can be increased. When the voltage of the power output terminal V is greater than the EMF of the rechargeable battery 13, the solar cell 11′ becomes the main power source for providing the power to the control module 14 and charging the rechargeable battery 13. When the environmental light is weak, the EMF of the solar cell 11′ is decreased, so that the voltage of the power output terminal V is decreased. When the voltage of the power output terminal V is smaller than the EMF of the rechargeable battery 13, the rechargeable battery 13 automatically becomes the main power source. In this case, the output of the solar cell 11′ is provided for charging the rechargeable battery 13 or directly to the load. The rechargeable battery 13 can ensure to provide the stable and continuous power source to the load.

In summary, the flush apparatus of the present invention can be applied with a small-size solar cell or in the condition of insufficient environmental light. The flush apparatus of the first embodiment can use the capacitor, boosting unit and isolation-determining circuit to boost the voltage of the solar cell. In addition, the solar cell is connected with the rechargeable battery in parallel, so that both the small-size solar cell and the rechargeable battery can be used as the power supply. When the large-size solar cell is used or the environmental light is sufficient, the solar cell and rechargeable battery, which are connected in parallel, can be used as the power supply without the boosting unit and the isolation-determining circuit. In this case, the solar cell can output electricity to the rechargeable battery continuously, thereby extending the using time of the rechargeable battery.

In addition, the flush apparatus of the present invention further includes the power line transmission module or Zigbee transceiving module, which is low power consumption, so that the control module 14 can output the detecting information such as a value of the voltage of the rechargeable battery and user number of the flush apparatus through the power line transmission module or the Zigbee transceiving module. Then, a master control terminal can modify a control loop program of the control module through the power line transmission module or the Zigbee transceiving module.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A flush apparatus, comprising:
a control module for controlling the flush apparatus to flush or not;
a solar cell; and
a rechargeable battery, wherein the solar cell and the rechargeable battery are electrically connected to a power output terminal in parallel, and the power output terminal is electrically connected to the control module for providing power to the control module.

2. The flush apparatus according to claim 1, wherein the solar cell receives an environmental light so as to charge the solar cell.

3. The flush apparatus according to claim 1 further comprising:
a solenoid valve electrically connected to the control module so that the control module controls ON/OFF of the solenoid valve.

4. The flush apparatus according to claim 1, further comprising:
a boosting unit disposed between the solar cell and the power output terminal for boosting the electricity outputted from the solar cell.

5. The flush apparatus according to claim 4, wherein the boosting unit is a booster.

6. The flush apparatus according to claim 4, further comprising:
an isolation-determining circuit having a first terminal electrically connected to the boosting unit and a second terminal electrically connected to the power output terminal, wherein the isolation-determining circuit is used for preventing the control module from retrieving current directly from boosting unit after the electricity of the solar cell is boosted by the boosting unit so as to avoid the voltage drop at the power output terminal such that the rechargeable battery cannot be charged.

7. The flush apparatus according to claim 6, further comprising:
a capacitor, wherein the capacitor and the solar cell are electrically connected to a node in parallel, the node is electrically connected to the boosting unit, and the capacitor is used to pre-store charges generated by the solar cell.

8. The flush apparatus according to claim 7, wherein a working voltage of the solar cell is smaller than an electromotive force (EMF) of the rechargeable battery.

9. The flush apparatus according to claim 7, further comprising:
a diode, wherein the solar cell is electrically connected to an anode of the diode, and a cathode of the diode is electrically connected to the node so as to prevent the current reverse back to the solar cell.

10. The flush apparatus according to claim 1, wherein when a voltage of the power output terminal is greater than an EMF of the rechargeable battery, the solar cell applies electricity to the control module and recharges the rechargeable battery, and when the voltage of the power output terminal is lower than the electromotive force of the rechargeable battery, the rechargeable battery applies electricity to the control module.

11. The flush apparatus according to claim 1, wherein the flush apparatus is an automatic flush urinal.

12. The flush apparatus according to claim 1, wherein the control module comprises a microcontroller.

13. The flush apparatus according to claim 1, further comprising:
a detecting unit electrically connected to the control module for detecting whether a user exists or not and then transmitting a detecting signal to the control module.

14. The flush apparatus according to claim 13, wherein the detecting unit is an infrared detecting unit.

15. The flush apparatus according to claim 13, wherein the detecting unit comprises a transmitter element and a receiver element, and whether the user exists is judged according to a reflected infrared signal emitted from the transmitter element and then reflected by the user.

16. The flush apparatus according to claim 1, wherein the control module provides a driving power source to the solenoid valve so as to control a flushing time of the flush apparatus according to a using time and/or a using frequency of a user.

17. The flush apparatus according to claim 1, further comprising a power line transmission module or a Zigbee transceiving module for bidirectional data transmission with the control module.

18. The flush apparatus according to claim 17, wherein the control module outputs a value of the electromotive force of the rechargeable battery and user number of the flush apparatus through the power line transmission module or the Zigbee transceiving module.

19. The flush apparatus according to claim 17, wherein a master control terminal modifies a control loop program of the control module through the power line transmission module or the Zigbee transceiving module.
